(19) United States
(12) Patent Application Publication
(10) Pub. No.: US 2024/0152813 A1
(43) Pub. Date: May 9, 2024

(54) METRICS FOR INSTANCE RANKING FOR CLASSIFICATION AND REGRESSION

(71) Applicant: Synopsys, Inc., Sunnyvale, CA (US)

(72) Inventors: Xiang GAO, San Jose, CA (US); Hursh NAIK, Sunnyvale, CA (US); Vincent LIN, San Jose, CA (US); Manish SHARMA, San Jose, CA (US)

(21) Appl. No.: 18/499,021

(22) Filed: Oct. 31, 2023

Related U.S. Application Data
(60) Provisional application No. 63/421,896, filed on Nov. 2, 2022.

(51) Int. Cl. G06N 20/00

(52) U.S. Cl. CPC G06N 20/00

(57) ABSTRACT

Machine learning (ML) processes ranks data instances to determine when to adjust parameters of a machine learning model. Data instances are ranked by receiving data instances. Further, ranked instances are determined based on the data instances and a machine learning model. A metric is determined based on the ranked instances. An adjusted machine learning model is generated by adjusting one or more parameters of the machine learning model based on the metric.

### RELATED APPLICATION

This application claims the benefit of U.S. provisional patent application Ser. No. 63/421,896, filed Nov. 2, 2022, which is hereby incorporated herein by reference.

### TECHNICAL FIELD

The present disclosure relates to ranking instances used to generate and adjust machine learning models.

### BACKGROUND

Machine learning (ML) processes apply ranking to information retrieval in query operations. In some instances, ML processes use supervised learning applications. A supervised learning application uses data that includes labelled examples for training. The goal of supervised learning applications is a learning function that maps feature vectors (inputs) to labels (output), based on example input-output pairs. In an ML process that employs supervised learning applications, the data predictions are ranked so that the most valuable predictions have the highest priority for execution given limited resources. In one example, when applying data predictions to detect defective batches, the most likely defective samples that were classified as defective are selected and tested first to more quickly identify the defective batches. In another example, in an optimization or reinforcement learning (RL) ML process, the seeds and/or actions that can offer the best reward at a given state are ranked. In iterative optimizations, the most uncertain predictions from ranking can be proposed for evaluation in the following round. In supervised learning, there are defined metrics that are used to evaluate the quality of data and corresponding model or models. For classification the metrics include accuracy, F-score, area under curve, and log loss, among others. For regression the metrics include mean square error (MSE), and mean absolute error, among others.

### SUMMARY

In one example, a method includes receiving data instances, and determining ranked instances based on the data instances and a machine learning model. Further, the method includes determining a metric based on the ranked instances. The method further includes outputting an adjusted machine learning model generated by adjusting one or more parameters of the machine learning model based on the metric.

In one example, a system includes a memory storing instructions, and a processor. The processor is coupled with the memory and is configured execute the instructions. The instructions when executed cause the processor to receive data instances, and determine ranked instances based on the data instances and a machine learning model. Further, the processor is caused to determine a metric based on the ranked instances. The processor is further caused output an adjusted machine learning model generated by adjusting one or more parameters of the machine learning model based on the metric.

In one example, a non-transitory computer readable medium comprising stored instructions, which when executed by a processor, cause the processor to receive data instances, and determine ranked instances based on the data instances and a machine learning model. The processor is further caused to determine ground truth ranked instances based on the data instances, ground truth data instances, and the machine learning model. The ground truth data instances are free from errors. Further, the processor is caused to determine a first metric based on the ranked instances and a second metric based on the ground truth ranked instances, and determine a ranking index based on a comparison of the first metric and the second metric. The processor is further caused to output an adjusted machine learning model generated by adjusting one or more parameters of the machine learning model based on the ranking index.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 illustrates a flowchart of a method for generating ranking curves and metrics for adjusting machine learning models, according to one or more examples.

FIG. 2 illustrates graphs of accuracy and recall from ranked data, according to one or more examples.

FIG. 3 graphs of ROC curves and precision recall curves that are used widely for supervised ML applications.

FIG. 4 illustrates graphs of various metrics at various noise levels, according to one or more examples.

FIG. 5 illustrates graphs of various errors at different noise levels, according to one or more examples.

FIG. 6 illustrates graphs of expected target values and regression recall values, according to one or more examples.

FIG. 7 depicts a diagram of an example computer system in which embodiments of the present disclosure may operate.

### DETAILED DESCRIPTION

Aspects of the present disclosure relate to metrics for instance ranking for classification and regression.

Machine learning (ML) processes use ranking of the information retrieval in query operations. Ranking of a query is a fundamental problem in information retrieval, and is used by search engines and other applications. Ranking is used so that the best results appear earlier (e.g., first) in a results lists (e.g., have a higher ranking). Ranking provides accurate and relevant results.

In ML, an instance (e.g., a data instance) is a row of data. An instance may be described by a number of features (e.g., attributes). In current ML processes data instance ranking for non-query applications, such as instances, is not utilized. As is described in greater detail herein, methods and metrics for ML predictions using instance ranking is described. The instance ranking may be used in addition to ML predictions. However, existing ML processes do not employ instance ranking. Further, the metrics that are commonly used for ranking, such top-N accuracy, mean reciprocal rank, discounted cumulative gain (DCG), and cumulative match curve, among others, are designed for information retrieval and are not applied to the instance ranking.

In one or more examples in supervised learning, metrics are used to evaluate the quality of data and model. For classification, the metrics include accuracy, F-score, area under curve (AUC), and log loss, among others. For regression, the metrics include mean square error (MSE), and mean absolute error, among others. However, for the instance ranking on top of classification and regression, such metrics are not usable. In the following, instance ranking metrics for classification and regression problems are described. The methods describe herein use the sorted target values along with a corresponding ground truth, and are not affected by density variations produced by the ranking scores or model predictions. Ground truth is associated with data that is known to be correct. Further, the method described herein can be applied to situations where no ML model is provided.

Technical advantages of the present disclosure include, but are not limited to, using top-n ranking curves for increased accuracy, recall, expected value, and reward, among others. The use of top-n ranking curves allows for direct observation of ranking quality and facilitate top-n subset selection. Further, a scaler ranking index is used during the evaluation of instance ranking quality to improve the generation of feature engineering and feature importance, among others. A unified framework for evaluating instance ranking for both classification and regression is used. Accordingly, using the methods described herein improve the ML predictions for instance ranking, improving the performance of the ML processes. In one example, for a data set {(Xᵢ, yᵢ)}, where X is the set of input data, y is the label, which might not be provided for the test data, a typical supervised learning problem is to build the model y(X; θ) so that |E (y)−E (ý)| is minimized. E(y) is the expected value of y, i.e., the ground truth, E(ý) is the expected value of prediction ý=y(X; θ). Ground truth is associated with data that is correct (e.g., error free). To rank the data prediction in supervised learning, a separate ranking score z either based on prediction y, or based on the prediction probability (e.g., confidence from model y(X; θ)) is used to sort {Xᵢ}, so that the top-n, or top-n% of instances from {Xᵢ} would either have higher priority or collect as much of the amount of the training reward as possible. The higher priority data set is expected to have better prediction accuracy, and/or MSE, among others, than the rest of the set. The instance ranking problem described herein includes ranking instances of data set {Xᵢ}, or {yᵢ}, with or without model predictions for each data Xᵢ, while the top-n prediction in ML classification problems is based on the ranking of likelihood of known target labels for one given input, P (y^{k}|X).

The ranking method described herein is directed to instance ranking different from data relevance ranking for a query for ML. The ranking method described herein is a unified ranking evaluation scheme for classification and regression. As is described in greater detail in the following, the top-n ranking curves for accuracy, recall, expected value, and reward, among others are described, and allow for direct determination of ranking quality, and facilitate top-n subset selection, among others. In one or more examples, a scalar ranking index is used to evaluate instance ranking quality. The scalar ranking index may be applied to ML processes including feature engineering and/or feature importance, among others, for instance ranking objectives. In one or more examples, a unified framework for evaluating instance ranking for both classification and regression is described herein.

The methods described herein are based on the ranked data with the ground truth and are not affected by the data density variations caused by the ranking score, such as probability value used in ROC, and/or precision-recall, among others. In one or more examples, instance counts are used directly, thus the method described here provides results on population directly. As is described in further detail in the following, a method for defining the top-n accuracy and recall ranking curves and ranking indices for single class classification are described. Further, multi-class classification can be defined similarly as described in the following. In one or more examples, each class type is treated as one single class classification problem. In another example, multiple targets are combined into one using a combined metric (e.g., such as combined accuracy). Accordingly, multi-target regression problem can be treated in the same way where each target variable can be treated separately or combined together. In the combined case, a scalar sum (combined reward) for multi-dimension target vectors can be used for combined expected value or combined regression recall.

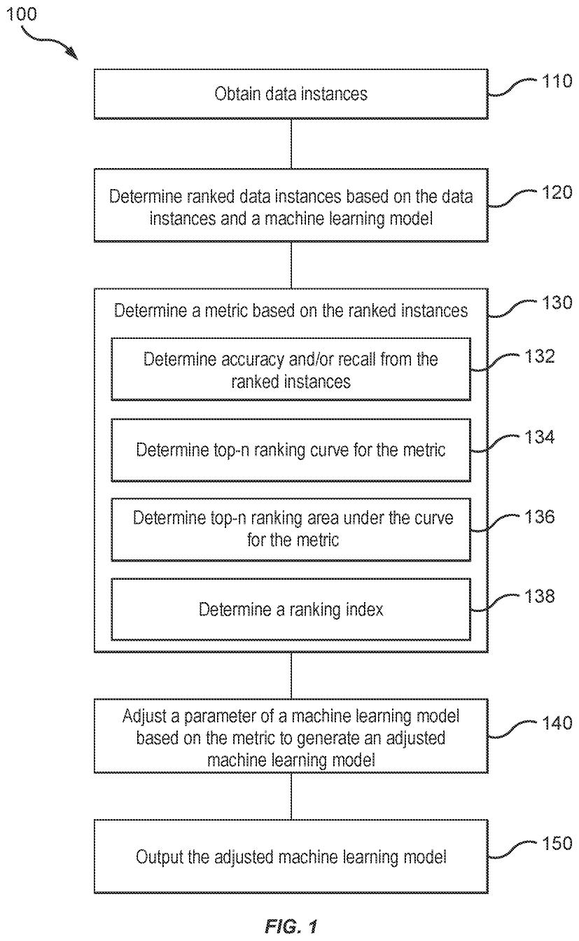

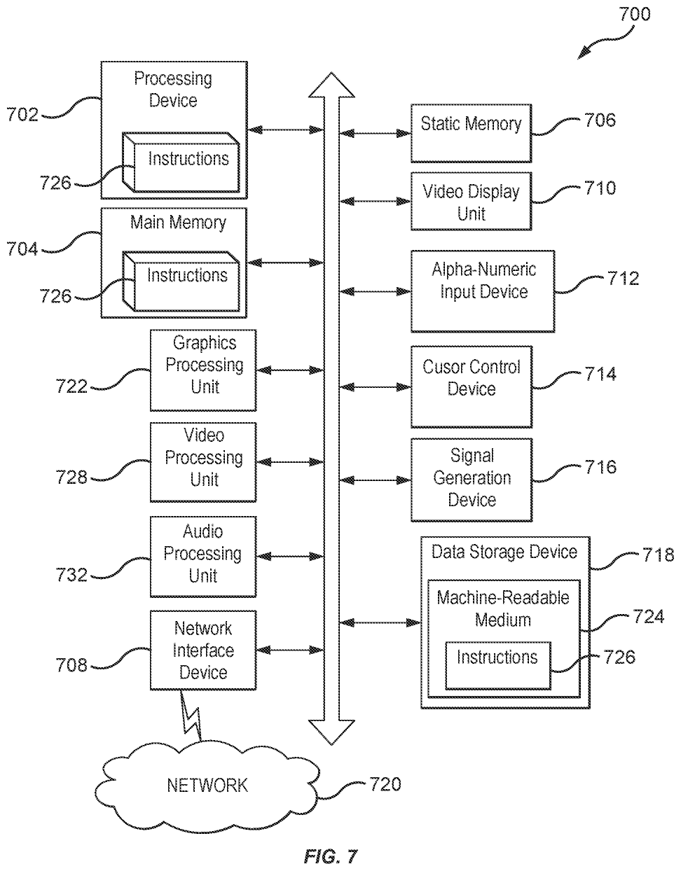

FIG. 1 illustrates a flowchart of a method 100, according to one or more examples. The method 100 is performed by a computer system (e.g., the computer system 700 of FIG. 7). For example, a processing device (e.g., the processing device 702 of FIG. 7) executes instructions (e.g., the instruction 726 of FIG. 7) stored within a memory device (e.g., the main memory 704 of FIG. 7 and/or the machine-readable storage medium 724 of FIG. 7) to perform the method 100.

At 110, data instances are obtain. For example, a processing device (obtains (e.g., receives) the data instances from a memory device, an input device (e.g., alpha-numeric input device 712 of FIG. 7), or another system via a network (e.g., the network 720 of FIG. 7). In one example, a data instance is a row of data. A collection of instances may be referred to as a dataset. In a dataset, data is organized in rows (e.g., data instances) and columns. The data columns may be features (or attributes of a data instance). A feature may be inputs to a model. The features have a data type, and may be real or integer-valued or have a categorical or ordinal value.

At 120, ranked data instances are determined based on the obtained data instances and an ML model. In one example, the processing device determines ranked data instances based on the obtained data instances and the ML model. The ML model can produce score(s) for the data instances. In such an example, the data instances can be ranked by the corresponding scores. The scores can be classification results, regression results, probability results, confidence results, etc. used in ML applications. Further, the processing device generates a function and a process. In one example, a ranking system that is part of the computer system is used to generate the ML model, the function and process.

In one example, a ground truth is obtained by the processing device, and the processing device generates ranked instances with ground truth based on the ranked instances and the ground truth. In one or more examples, an ML model (e.g., a ranker) produces a ranking score zᵢ for a data instance Xᵢ based on the associated prediction ýᵢ or other metrics. The instance ranking metric may not rely on how ranking score is produced, or even whether ranking score is used or not. The ranking metric uses the ranked ground truth [yᵢ] regardless of the existence of prediction [ýᵢ]. Accordingly, the effects from z and y(X; θ), etc. are eliminated. In one or more examples, if ranking score “z” is used in ranking and has many duplicated values making ranking un-deterministic, “z” in the following area under the curve (AUC) computations is used as described in further detail in the following.

At 130, a metric based on the ranked instances is determined. In one example, the processing device determines a metric from the ranked instances and/or perfectly ranked instances. The perfectly ranked instances are determined from the ranked instances with ground truth. At 132, determining a ranked instances includes determining an accuracy metric and/or a recall metric, among others. In one example, the processing device determines an accuracy metric from the ranked instances. In another example, the processing device determines a recall metric from the ranked instances. Further, the processing device determines another metric type from the ranked instances. In one or more examples, the processing device determines an accuracy metric, a recall metric from the ground truth ranked instances, and/or another metric type from the ground truth ranked instances.

For single class classification problems, the prediction value {ýᵢ} sorted by ranking score zᵢ. In one or more examples, the ranking score zᵢ is the prediction probability. The ranking score zᵢ may be the same variable used in ROC (Receiver Operating Characteristic), and prediction-recall, among others. The top-n subset, indicated as (i≤n), is treated as true positives. In one or more examples, determining the metric based on the ranked instances includes determining a recall and accuracy for top-n. In one example, the accuracy and the recall metrics are determined for ranked instances and for perfectly ranked instances determined from the ground truth instances. The accuracy of the top-n instances determined via Equation 1.

$$accuracy ( i \leq n ) = \frac{T P ( i \leq n )}{T P ( i \leq n ) + N P ( i \leq n )} = \frac{T P ( i \leq n )}{n} . \qquad Equation 1$$

In equation 1, the top-n instances are treated as positive instances. Accordingly, the class decision boundary is the sorted index, or a group of indices in an example where there are duplicates of the ranking score. In one or more example, treating the top-n instances as positive is different from the class decision boundary based on prediction probability used in ROC and precision-recall analysis processes. Accordingly, the ranking process described herein differs from other ML metrics. In the ranking process described herein, the instance counts directly reflect the population density of a data set, while threshold values from prediction probabilities are skewed based on the population density.

At 134, determining a metric based on the ranked instances includes determining a top-n ranking curve for the metric is determined. The processing device generates the top-n ranking curve by plotting the values of the metric for percentage of data instances. A top-n ranking curve is generated for each metric. Further, a top-n ranking curve is generated for both the metrics generated from the ranked instances and the metric generated from the perfectly ranked instances.

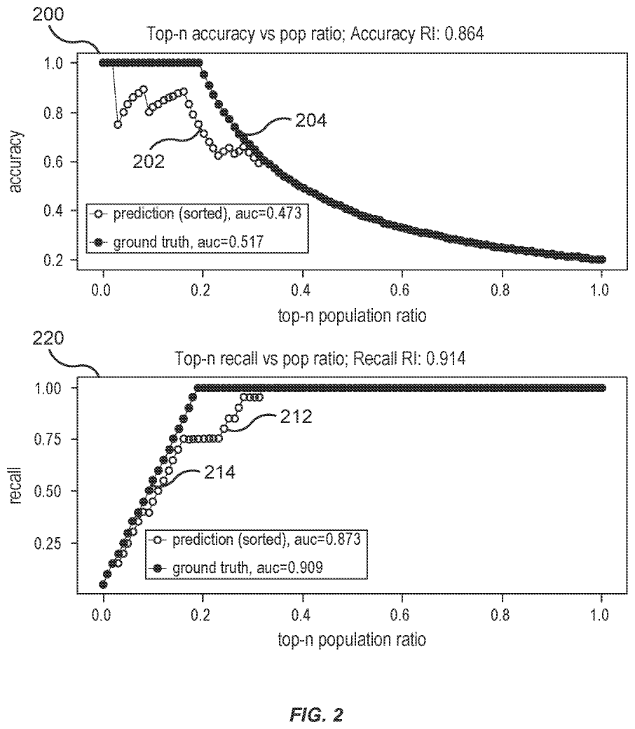

In one example, “n” vs accuracy(i≤n) is plotted. For good ranking results, small values of “n” should have high accuracies and the accuracy reduces as “n” increases. Such an example is shown by curve 202 of graph 200 of FIG. 2. In one or more examples, as is described in the following, a scaler metric is derived from the curve 202, which may be used in ranking. FIG. 2 illustrates a graph 200 illustrating a top-n accuracy ranking curve, and a graph 220 that is that is a top-n recall ranking curve.

In one example, for all possible n ∈ {1, . . . , N} in different top-n scenarios, the expected value of accuracy(i≤n) is the numeric average of the top-n accuracy ranking curves as defined by equation 2.

$$E ( accuracy ( i \leq n ) ) = \frac{1}{N} {\sum }_{n = 1 , … , N} accuracy ( i \leq n ) . \qquad Equation 2$$

In a continuous space, the top-n% scenarios from infinite instances with N=∞ and n ∈ [0,1] as a ratio from the infinite instances are considered. In such an example, the expected accuracy(x≤n) is shown in Equation 3.

E(accuracy(x≤n))=∫₀¹ accuracy(x≤n)ρ(x)dx Equation 3

In equation 3, ρ(x) is the density function with ∫₀¹ ρ(x)dx=1. In an example where uniform sampling is applied, ρ(x)=1. Further, for precision-recall and methods that rely on a ranking score z to group instances, the instance count based on x, is used instead of z, allowing for direct evaluation of a population. Further, in examples when the ranking score z has two or more identical score values, sorting z is not deterministic when used in sort algorithms that produce one solution. In one or more examples to improve the ranking of z, noise is added to z to produce different ranking solutions, and/or instances are grouped by z first, then used compute n or x on the groups. Adding noise to z various the value of z in a positive and/or negative direction based on value of the noise. In such examples, ρ(x)=1 as x is based on instance counts.

In one or more examples, the recall by top-n data instances may be determined. In such examples, ranking is scored through high recall with minimal efforts (the n in top-n). Equation 6 defines the top-n recall.

$$recall ( i \leq n ) = \frac{T P ( i \leq n )}{t o t P} \qquad Equation 4$$

In the graph 220 of FIG. 2, curve 212 illustrates n plotted vs recall(i≤n). The curve 212 may be referred to as a top-n recall ranking curve. The graph 210 further includes curve 214, which is the ground truth curve.

At 136, determining a metric based on the ranked instances further includes determining a top-n ranking AUC for the metric. The processing device determines a top-n ranking AUC for each metric from a corresponding top-n ranking curve. The top-n ranking AUC is determined for the metrics for the ranked instances and the metrics for perfectly ranked instances based on the following. Equation 3 is simplified to generate equation 5 below.

E(accuracy (i≤n))=∫₀¹ accuracy(x≤n)dx=AUC (n,accuracy(i≤n)) Equation 5

Comparing equation 5 to equation 2 shows that equation 5 is more accurate and stable than equation 2 in examples where sorting is not deterministic. Note, the parameter AUC of the expected value of the ranking curves may be used instead of the average value throughout the following description.

The top-n ranking curve from the test ranking is compared with perfect ranking and random ranking. A top-n ranking curve is determined based on the ranking instances and a top-n ranking curve is determined based on the perfectly ranked instances based on the above description. The curve 204 of graph 200 of FIG. 2 is determined from a perfect ranking solution, obtained from a ground truth. Ground truth is associated with data that is known to be correct. In one or more examples, a random ranking solution and corresponding expected accuracy is a

$$constant line at = \frac{T P ( i \leq N )}{T P ( i \leq N ) + F P ( i \leq N )} = \frac{totP}{N} ,$$

which is the prior probability of the positive instances.

At 138, determining a metric based on the ranked instances includes determining a ranking index. The processing devices determines a ranking index by comparing the AUC for metrics associated with ranked instances with a corresponding AUC for a metric associated the metrics of the perfectly ranked instances to determine. For example, the ranking score can be compared against a perfect ranking and a random ranking and produce a normalized ranking index. Equation 6 defines how an accuracy ranking index is determined.

$$Accuracy Ranking Index = \frac{A U {C}_{test} - A U {C}_{random}}{A U {C}_{perfect} - A U {C}_{random}} = \frac{A U {C}_{test} - η}{- η log ( η )} \qquad Equation 6$$

In equation 6,

$$= \frac{totP}{N} ,$$

AUC_{random}=η, and AUC_{perfect}=η=ηlog (η), which can

be derived based on the integral of equation 1 in the continuous space. The scalar ranking index value from equation 6 is in general between [0, 1], with 1 as perfect ranking, 0 as random ranking. Negative value is possible, representing opposite ranking and values below random ranking. In one example, a random ranking is 0.2 (or other values greater than 0). In such an example, values of less than the random ranking (e.g., less than 0.2) are negative values.

A recall ranking index is defined based on equation 7.

$$Recall Ranking Index = \frac{A U {C}_{test} - A U {C}_{random}}{A U {C}_{perfect} - A U {C}_{random}} = \frac{A U {C}_{test} - 1 / 2}{1 / 2 - η / 2} \qquad Equation 7$$

In equation 7, AUC_{random}=½, and

$$A U {C}_{perfect} = 1 - \frac{η}{2} ,$$

with

$$η = \frac{totP}{N} .$$

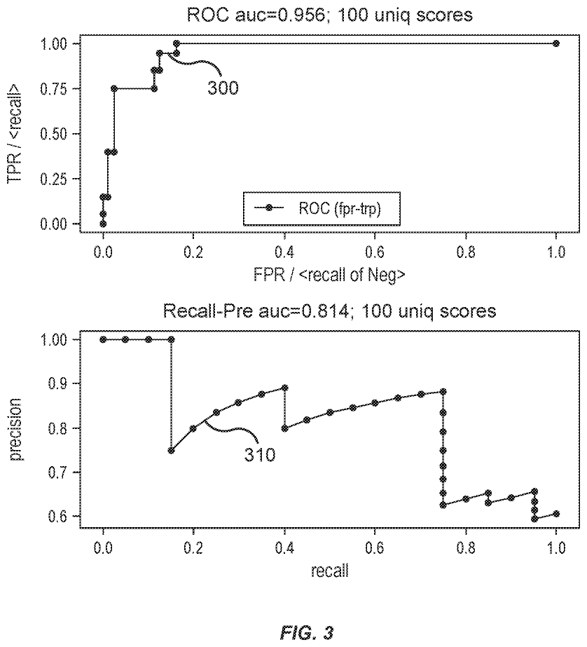

The accuracy and recall ranking curves 202 and 212 in FIG. 2 illustrate the accuracy and recall for top-n ranking with various n. Further, the curves 202 and 212 illustrate how the accuracy and recall ranking indices are determined from the corresponding area under the curves (AUCs) to represent the quality of the corresponding ranking. In comparison, the ROC and precision-recall curves generally used in classification problems do not provide information regarding instance ranking directly. For example, as illustrated in FIG. 3, the ROC curve 300 and recall curve 310 do not provide information regarding instance ranking.

In various examples, AUC is used as the scalar metric of the curves. However, there are some drawbacks of relying on ROC and precision-recall curves, and the corresponding AUCs. For example, the metrics are based on prediction probability, and, in such instances, the metrics are invalid when instance ranking is not based on prediction probability. Further, the data density may be skewed by the probability ρ(z), increasing the difficulty in making a true estimation of data population. Additionally, when the number of unique values of the prediction probability is small, the AUC becomes inaccurate. In one or more examples, the precision-recall curve is strongly affected by the class imbalances, and the precision-recall is problematic when training and test data have different class imbalances. Further, in one or more examples, the ROC and recall may not be easily applied to regression problems.

In addition to the comparison of top-n accuracy and recall ranking curves with the ROC and precision-recall curves, the top-n accuracy and recall ranking curves are compared under different class imbalance scenarios, and different number of errors introduced to the predictions, among others. To perform these comparisons, prediction probability ýᵢ is simulated without using a data set or an ML model. In one example, Xᵢ is sampled among [−10, 0) (for negative labels) and [0, 10] (for positive labels) with positive ratio of 10%, 50%, 70% representing three scenarios. Further, the prediction probability

$${ý}_{i} = \frac{1}{1 + {e}^{- {X}_{i} + norm ( {σ}_{x} )}} + norm ( {σ}_{y} )$$

is simulated with noise added to Xᵢ and ýᵢ and with a noise level of σₓ and σ_{y} respectively. Further, non-uniform sampling may be applied to Xᵢ. The simulated prediction probability ýᵢ is used in ROC, precision-call and ranking as described herein. In one or more examples, the ground truth yᵢ=sign(Xᵢ) is obtained without noise.

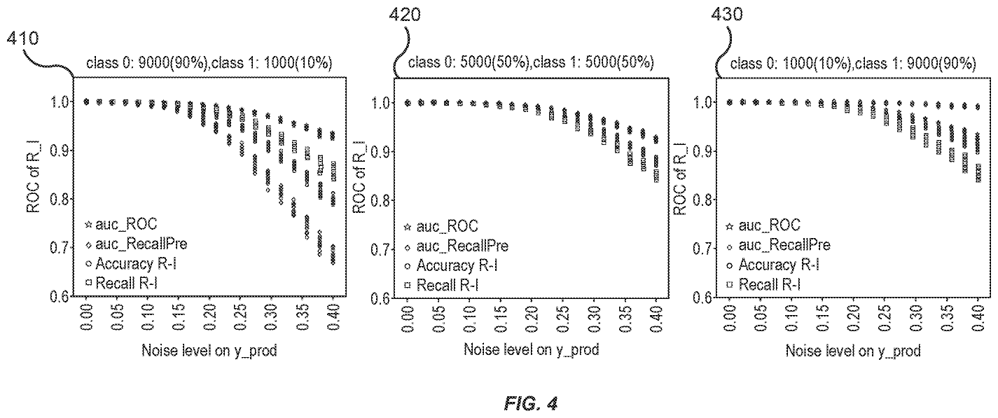

In the example of FIG. 4, the noise level σₓ is fixed at 0.1, while σ_{y} varies from 0 to 0.4 for three class imbalance scenarios shown in graphs 410, 420, and 430. Class imbalances correspond to when the distribution of examples with a database is skewed or biased, and can lead to a bias in the trained model. The graphs 410, 420, and 430 of FIG. 4 illustrate simulated scenarios of ranking 10K instances, with three ratios of positive labels: 10%, 50% and 70%. The AUCs and Ranking Indices (R-I) are plotted against noise level σ_{y}.

As can be seen from the graphs 410, 420, and 430 of the accuracy R-I, recall R-I and ROC_AUC are more stable against class imbalances than precision-recall AUC, i.e., have a higher consistency when dealing with data sets with different population ratios of labels. Further, the accuracy R-I and recall R-I have a larger dynamic range than ROC_AUC, i.e., have an increased sensitivity to effects that affect ranking results In one or examples, the simulations (e.g., experiments) are repeated 20 times for each σ_{y} value, and the two (accuracy and recall) R-Is have consistent larger variations in repeated experiments when noise level σ_{y} increases. This may indicate that ranking results are heavily affected by the large noise levels with σ_{y}>0.3, while the other two metrics are insensitive to ranking result changes.

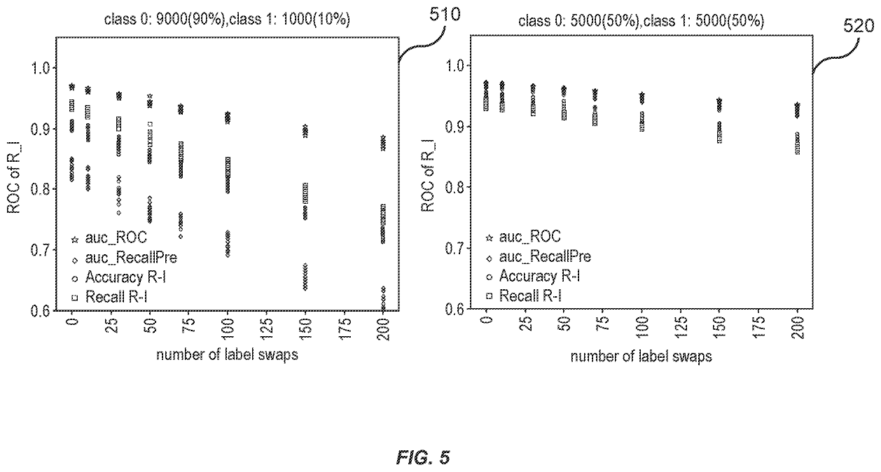

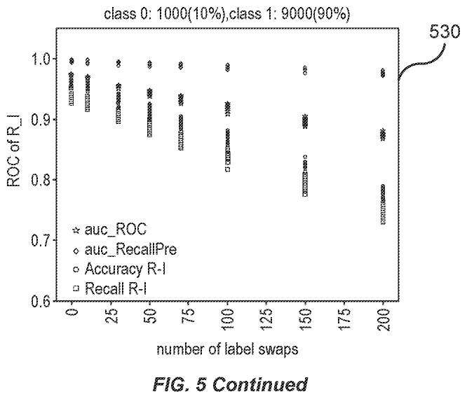

As illustrated in graphs 510, 520, and 530 of FIG. 5, σₓ=0.1 and σ_{y}=0.2, additional label errors are introduced by swapping negative and positive label pairs. The number of label swaps are shown along the x-axis in each graph 510, 520, and 530 of FIG. 5.

In the examples of graphs 510, 520, and 530 FIG. 5, the simulated scenarios of ranking 10K instances, with three ratios of positive labels: 10%, 50% and 70% are shown. The AUC for ROC and Recall and Ranking Indices (R-Is) for accuracy and recall are plotted against number of randomly swapped positive and negative instance pairs (errors).

In one or more examples, the metrics used in regression are mean square error (MSE), mean absolute error, and Tweedie score, among others. Such metrics may be applied to the ranking problem described herein using the same method as defined herein for classification. In one example for the metric (i≤n), the metric can be MSE. As is described herein, the expected value of top n ranked instances, which can be compared with perfect ranking and random ranking, is defined in equation 8.

$$E ( {ý}_{i} \vert i \leq n ) = \frac{{\sum }_{i \leq n} {ý}_{i}}{n} \qquad Equation 8$$

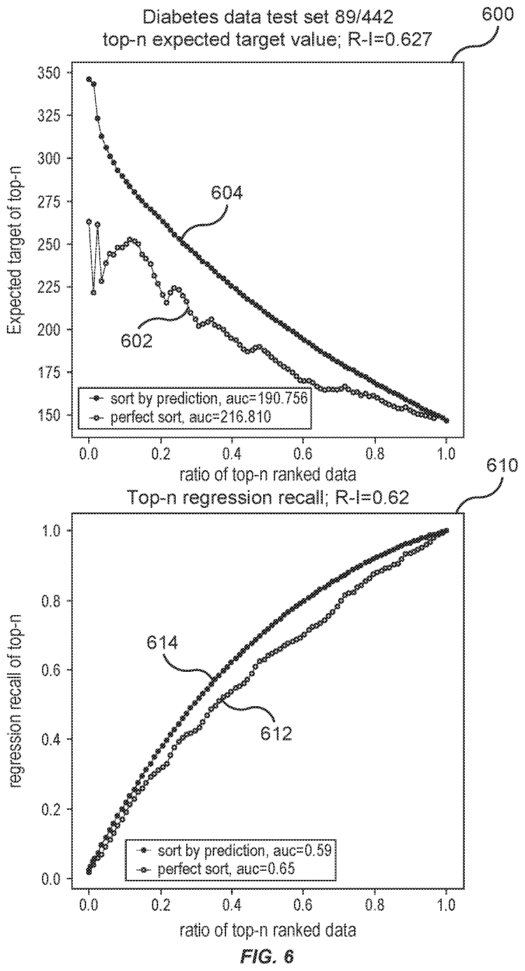

In equation 8, ýᵢ is the ground truth ranked by the model. As can be seen from equation 8, n vs E(ýᵢ|i≤n) is plotted as illustrated in graph 500 of FIG. 5. As illustrated by the graph 600 of FIG. 6, the expected top-n ranked values change as n increases. The curve 602 is called expected value ranking curve and the curve 604 is the ground truth curve. The ground truth curve is generated based on ground truth instances. The expected value of the expected value of top-n instances is determined based on the AUC of the n vs E (ýᵢ|i≤n) curve as defined equation 9.

$$E ( E ( {ý}_{i} \vert i \leq n ) ) = A U C ( n , E ( {ý}_{i} \vert i \leq n ) ) \approx \frac{1}{N} {\sum }_{n = 1 , … , N} E ( {ý}_{i} \vert i \leq n ) \qquad Equation 9$$

In one or more examples, for perfect ranking, the expected value of top n instances is performed on perfectly ranked ground truth y as described in equation 10.

$$E ( {y}_{i} \vert i \leq n ) = \frac{{\sum }_{i \leq n} {y}_{i}}{n} \qquad Equation 10$$

As can be seen, equation 8 differs from equation 10. For random ranking, the expected value of top-n instances is a constant that is prior expected value. The prior expected value is defined by equation 11.

$$E ( {y}_{i \_ rand} \vert i\_rand \leq n ) = \frac{{\sum }_{i \leq N} {y}_{i \_ rand}}{N} = \overline{y} \qquad Equation 11$$

Equation 12 defines the expected target ranking index for regression.

$$Expected Target Ranking Index = \frac{A U {C}_{test} - A U {C}_{random}}{A U {C}_{perfect} - A U {C}_{random}} = \frac{A U C ( n , E ( {ý}_{i} \vert i \leq n ) ) - \overline{y}}{A U C ( n , E ( {y}_{i} \vert i \leq n ) ) - \overline{y}} \qquad Equation 12$$

In one or more examples for regression, the expected value of top-n instances is

$$E ( {ý}_{i} \vert i \leq n ) = \frac{{\sum }_{i \leq n} {ý}_{i}}{n} .$$

For binary classification, 1 and 0 may be used for positive and negative labels respectively. In such an example, the accuracy corresponds to the expected value in equation 8, establishing a common foundation of ranking indices for both classification and regression. In one or more examples, the determination of regression and/or classification does not rely on how the ranking score z is computed. In regression, prediction ý is used as the ranking score z. A similar analysis is applied in examples where a separate ranking score z is used.

In one or more examples, the concept of recall is extended from classification to regression. In such an example, the target value y is used as reward, and the ranking objective collects as much as reward as possible (e.g., the n in top-n). Further, the ratio of reward collected from total reward in regression is similar to recall in a corresponding classification problem. Equation 13 illustrates how the top-n recall of equation 6 that is used for classification can be modified for regression.

$$regression\_recall ( i \leq n ) = \frac{{\sum }_{i \leq n} {y}_{i}}{\vert {\sum }_{i \leq N} {y}_{i} \vert} \qquad Equation 13$$

In one or more examples, recall as defined for regression in equation 13 is the ratio of top-n total reward over the total reward of the whole data set. For binary classification problems, where positive targets with reward y=1, negative targets with reward y=0, equation 6 and equation 13 are equivalent. Equation 13 is the top-n reward ratio, or regression recall, and may be used to differentiate the recall in classification. In one or more examples, reward y≥0, but y<0 may be used as penalty values. The denominator in equation 13 has an absolute sign, which ensures that top-n recall is not affected by the sign of total reward in case it is negative. To ensure stability, the net reward from all data should not equal to zero, i.e. Σ_{i≤N} yᵢ≠0.

Further in the curve 612 of graph 610 of FIG. 6, n vs regression_recall(i≤n) is plotted. Curve 614 of FIG. 6 illustrates a ground truth curve. A top-n regression recall based ranking index, RRR-Index, is defined in equation 14.

$$RRR Index = \frac{A U {C}_{test} - A U {C}_{random}}{A U {C}_{perfect} - A U {C}_{random}} = \frac{A U {C}_{test} - sign ( {\sum }_{i \leq N} {y}_{i} ) / 2}{A U {C}_{perfect} - sign ( {\sum }_{i \leq N} {y}_{i} ) / 2} \qquad Equation 14$$

In equation 14,

$$A U {C}_{random} = \frac{sign ( {\sum }_{i \leq N} {y}_{i} )}{2} .$$

In one or more examples in graph 600 of FIG. 6, the top-n expected target value is plotted. In graph 610 of FIG. 6, the regression recall for top-n regression recall plot for diabetes data set with training and test split equals 80:20 is plotted. The graphs 600 and 610 of FIG. 6 illustrate the top-n ranking plots for a randomly subsampled 20% test data set in the diabetes data set, with 80% for training. The data set has 442 instances, with 10 numeric predictive features and 1 scalar target. A regression model may be used to fit the training data and perform prediction on the test data.

In one example, one or more of 132-138 may be performed for multiple metrics during at least partially overlapping periods. In one or more examples, one or more of 132-138 for a first metric and one or more of 132-138 for a second metric are performed during non-overlapping periods. In one or more example, one or more of 132-138 may be performed for a metric generated from the ranked instances and one or more of 132-138 may be performed for a metric generated from the ground truth ranked instances during at least partially overlapping periods or during non-overlapping periods.

At 140, a parameter of a machine learning model is adjusted based on the metric to generate an adjusted machine learning model. For example, the processing device determines an adjustment value based on the top-n ranking curve, the top-n ranking AUC, and the ranking index. The adjusted value is applied as feedback to adjust the ranking curves (e.g., the top-n ranking curves and/or the top-n ranking AUCs), the top-n recall indices and/or the top-n accuracy indices. In one example, the processing devices adds one or more features, layers of data, or using a scalar value to adjust the machine learning model and/or the ranking curves and indices.

At 150, the adjusted machine learning module is output. For example, the processing device outputs the adjusted machine learning module to a memory device. In one example, the adjusted machine learning module is output to another system via a network interface device and a corresponding network by the processing device.

FIG. 7 illustrates an example machine of a computer system 700 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random access memory (DRAM) such as synchronous DRAM (SDRAM), a static memory 706 (e.g., flash memory, static random access memory (SRAM), etc.), and a data storage device 718, which communicate with each other via a bus 730.

Processing device 702 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 may be configured to execute instructions 726 for performing the operations and steps described herein.

The computer system 700 may further include a network interface device 708 to communicate over the network 720. The computer system 700 also may include a video display unit 710 (e.g., a liquid crystal display (LCD) or a cathode ray tube (CRT)), an alpha-numeric input device 712 (e.g., a keyboard), a cursor control device 714 (e.g., a mouse), a graphics processing unit 722, a signal generation device 716 (e.g., a speaker), graphics processing unit 722, video processing unit 728, and audio processing unit 732.

The data storage device 718 may include a machine-readable storage medium 724 (also known as a non-transitory computer-readable medium) on which is stored one or more sets of instructions 726 or software embodying any one or more of the methodologies or functions described herein. The instructions 726 may also reside, completely or at least partially, within the main memory 704 and/or within the processing device 702 during execution thereof by the computer system 700, the main memory 704 and the processing device 702 also constituting machine-readable storage media.

In some implementations, the instructions 726 include instructions to implement functionality corresponding to the present disclosure. While the machine-readable storage medium 724 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 702 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
receiving data instances;
determining, by a processor, ranked instances based on the data instances and a machine learning model;
determining a metric based on the ranked instances; and
outputting an adjusted machine learning model generated by adjusting one or more parameters of the machine learning model based on the metric.

2. The method of claim 1, wherein determining the metric includes determining at least one selected from the group consisting of accuracy and recall.

3. The method of claim 1, wherein determining the metric includes generating ground truth ranked instances based on the ranked instances and ground truth instances, wherein the ground truth instances corresponds to error free data.

4. The method of claim 3, wherein determining the metric includes generating a first ranking curve based on the metric.

5. The method of claim 4, wherein determining the metric includes determining a first area under curve of the first ranking curve.

6. The method of claim 5, wherein determining the metric includes generating a second ranking curve based on the ground truth ranked instances.

7. The method of claim 6, wherein determining the metric includes determining a second area under curve of the second ranking curve.

8. The method of claim 7, wherein determining the metric includes determining a ranking index based on the first area under curve and the second area under curve, and wherein the one or more parameters of the machine learning model are adjusted based on at least one of the ranking index and the first area under curve.

9. A system comprising:
a memory storing instructions; and
a processor, coupled with the memory and configured to execute the instructions, the instructions when executed cause the processor to:
receive data instances;
determine ranked instances based on the data instances and a machine learning model;
determine a metric based on the ranked instances; and
output an adjusted machine learning model generated by adjusting one or more parameters of the machine learning model based on the metric.

10. The system of claim 9, wherein determining the metric includes determining at least one selected from the group consisting of accuracy and recall.

11. The system of claim 9, wherein determining the metric includes generating ground truth ranked instances based on the ranked instances and ground truth instances, wherein the ground truth instances corresponds to error free data.

12. The system of claim 11, wherein determining the metric includes generating a first ranking curve based on the metric.

13. The system of claim 12, wherein determining the metric includes determining a first area under curve of the first ranking curve.

14. The system of claim 13, wherein determining the metric includes generating a second ranking curve based on the ground truth ranked instances.

15. The system of claim 14, wherein determining the metric includes determining a second area under curve of the second ranking curve.

16. The system of claim 15, wherein determining the metric includes determining a ranking index based on the first area under curve and the second area under curve, and wherein the one or more parameters of the machine learning model are adjusted based on at least one of the ranking index and the first area under curve.

17. A non-transitory computer readable medium comprising stored instructions, which when executed by a processor, cause the processor to:
receive data instances;
determine ranked instances based on the data instances and a machine learning model,
determine ground truth ranked instances based on the data instances, ground truth data instances, and the machine learning model, wherein the ground truth data instances are free from errors;
determine a first metric based on the ranked instances and a second metric based on the ground truth ranked instances;
determine a ranking index based on a comparison of the first metric and the second metric; and
output an adjusted machine learning model generated by adjusting one or more parameters of the machine learning model based on the ranking index.

18. The non-transitory computer readable medium of claim 17, wherein the processor is further caused to generate a first ranking curve based on the first metric and a second ranking curve based on the second metric.

19. The non-transitory computer readable medium of claim 18, wherein the processor is further caused to determine a first area under curve of the first ranking curve and a second area under curve of the second ranking curve.

20. The non-transitory computer readable medium of claim 19, wherein determining the ranking index comprises determining the ranking index based on a comparison of the first area under curve and the second area under curve.
